(19) United States
(12) Patent Application Publication
(10) Pub. No.: US 2014/0316833 A1
(43) Pub. Date: Oct. 23, 2014

(54) FEEDBACK BASED MODEL VALIDATION AND SERVICE DELIVERY OPTIMIZATION USING MULTIPLE MODELS

(71) Applicant: International Business Machines Corporation, Armonk, NY (US)

(72) Inventors: Yixin Diao, White Plains, NY (US); Aliza R. Heching, Bronx, NY (US); David M. Northcutt, Chester, NJ (US); George E. Stark, Austin, TX (US)

(21) Appl. No.: 14/318,739

(22) Filed: Jun. 30, 2014

Related U.S. Application Data
(63) Continuation of application No. 13/342,229, filed on Jan. 3, 2012.

(51) Int. Cl. G06Q 10/06; G06Q 50/28

(52) U.S. Cl. CPC G06Q 10/063112; G06Q 50/28
USPC 705/7.14

(57) ABSTRACT

An approach for modeling a service delivery system is presented. Data from the service delivery system is collected. Discrete event simulation, queueing, and system heuristics models are constructed from the collected data. Based on the constructed models, a first utilization error indicating first variations among measures of utilization of staffing by the service delivery system is determined. Based on the first utilization error, a problem that causes the first variations is determined and in response, adjustments to the models to correct the problem are determined. A second utilization error is determined. The second utilization error indicates second variations among other measures of the utilization of staffing by the service delivery system which are based on the adjustments. Based on the second utilization error, a consistency among the adjusted models is determined, and in response, an initial recommended model of the service delivery system is derived.

This application is a continuation application claiming priority to Ser. No. 13/342,229 filed Jan. 3, 2012.

### TECHNICAL FIELD

The present invention relates to a data processing method and system for validating a model, and more particularly to a technique for validating a model and optimizing service delivery.

### BACKGROUND

Known methods of modeling information technology (IT) service delivery systems include an explicit use of one type of model (e.g., queueing model or discrete event simulation model). Other known methods of modeling IT service delivery systems use multiple models to build best of the breed models (i.e., select one model from a bank of models through the use of an arbitrator based on arbitration policies), hybrid models (e.g., using agent-based models and system dynamics models to represent different aspects of a system), and staged models (e.g., building a deterministic model first, and then building a stochastic model to capture stochastic behaviors).

### BRIEF SUMMARY

In first embodiments, the present invention provides a method of validating a model. The method includes a computer collecting data from a system being modeled. The method further includes the computer constructing first and second models of the system from the collected data. The method further includes, based on the first model, the computer determining a first determination of an aspect of the system. The method further includes, based on the second model, the computer determining a second determination of the aspect of the system. The method further includes the computer determining a variation between the first and second determinations of the aspect of the system. The method further includes the computer receiving an input for resolving the variation, and in response, the computer deriving a model of the system that reduces the variation.

In second embodiments, the present invention provides a method of modeling a service delivery system. The method includes a computer system collecting data from the service delivery system. The method further includes the computer system constructing first and second models of the service delivery system from the collected data. The method further includes, based on the first model, the computer system determining a first staff utilization of the service delivery system across one or multiple pools. The method further includes, based on the second model, the computer system determining a second staff utilization of the service delivery system across the one or multiple pools. The method further includes the computer system determining utilization errors based on variations between the first and second staff utilizations across the one or multiple pools. The method further includes the computer system deriving an initial recommended model based on the utilization errors. The method further includes the computer system receiving performance indicating factors for performance across the one or multiple pools. The method further includes the computer system determining trend differences by comparing the initial recommended model and the performance indicating factors. The method further includes the computer system deriving a subsequent recommended model based on the trend differences. The subsequent recommended model reduces at least one of the utilization errors and the trend differences.

In third embodiments, the present invention provides a computer system including a central processing unit (CPU), a memory coupled to the CPU, and a computer-readable, tangible storage device coupled to the CPU. The storage device contains program instructions that, when executed by the CPU via the memory, implement a method of modeling a service delivery system. The method includes the computer system collecting data from the service delivery system. The method further includes the computer system constructing first and second models of the service delivery system from the collected data. The method further includes, based on the first model, the computer system determining a first staff utilization of the service delivery system across one or multiple pools. The method further includes, based on the second model, the computer system determining a second staff utilization of the service delivery system across the one or multiple pools. The method further includes the computer system determining utilization errors based on variations between the first and second staff utilizations across the one or multiple pools. The method further includes the computer system deriving an initial recommended model based on the utilization errors. The method further includes the computer system receiving performance indicating factors for performance across the one or multiple pools. The method further includes the computer system determining trend differences by comparing the initial recommended model and the performance indicating factors. The method further includes the computer system deriving a subsequent recommended model based on the trend differences. The subsequent recommended model reduces at least one of the utilization errors and the trend differences.

In fourth embodiments, the present invention provides a computer program product including a computer-readable, tangible storage device having computer-readable program instructions stored therein, the computer-readable program instructions, when executed by a central processing unit (CPU) of a computer system, implement a method of modeling a service delivery system. The method includes the computer system collecting data from the service delivery system. The method further includes the computer system constructing first and second models of the service delivery system from the collected data. The method further includes, based on the first model, the computer system determining a first staff utilization of the service delivery system across one or multiple pools. The method further includes, based on the second model, the computer system determining a second staff utilization of the service delivery system across the one or multiple pools. The method further includes the computer system determining utilization errors based on variations between the first and second staff utilizations across the one or multiple pools. The method further includes the computer system deriving an initial recommended model based on the utilization errors. The method further includes the computer system receiving performance indicating factors for performance across the one or multiple pools. The method further includes the computer system determining trend differences by comparing the initial recommended model and the performance indicating factors. The method further includes the computer system deriving a subsequent recommended model based on the trend differences. The subsequent recommended model reduces at least one of the utilization errors and the trend differences.

Embodiments of the present invention generate a model of an information technology service delivery system, where the model self-corrects for inaccuracies by integrating multiple models. By deriving a single, consistent, validated model that reduces the effect of combining data from multiple highly variable data sources, which include data that often has low levels of accuracy, practitioners may use the derived model to optimize the service delivery process.

### BRIEF DESCRIPTION OF THE SEVERAL VIEWS OF THE DRAWINGS

FIG. 1 is a block diagram of a system for validating a model using multiple models and feedback-based approaches, in accordance with embodiments of the present invention.

FIG. 2 is a flowchart of a process of validating a model using multiple models, where the process is implemented in the system of FIG. 1, in accordance with embodiments of the present invention.

FIGS. 3A-3C depict a flowchart of a process of feedback-based model validation and service delivery optimization using multiple models, where the process is implemented in the system of FIG. 1, in accordance with embodiments of the present invention.

FIG. 4 is a block diagram of a computer system that is included in the system of FIG. 1 and that implements the process of FIG. 2 or the process of FIGS. 3A-3C, in accordance with embodiments of the present invention.

### DETAILED DESCRIPTION

### Overview

Embodiments of the present invention recognize that modeling an IT service delivery system using known techniques is challenging because of system data that is incomplete, inaccurate, has uncertainties, has a large variation and/or is collected from multiple sources, and because of difficulties in building an accurate service model. Embodiments of the present invention acknowledge and reduce the effect of multiple sources of variation in the modeling process by using multiple models simultaneously and feedback loops for self-validating the modeling accuracy, without an arbitrator. The integration of multiple models and feedback loops to self-validate for modeling inaccuracy may ensure a derivation of a single model that reduces overall variation, which helps practitioners optimize the service delivery process.

Embodiments of the present invention use multiple models and feedback loops to improve modeling accuracy in order to provide an optimization of a system, such as an IT service delivery system (a.k.a. service delivery system). A service delivery system delivers one or more services such as server support, database support and help desks. Modeling consistency is checked across the multiple models, and feedback loops provide self-correcting modeling adjustments to derive a single consistent and self-validated model of the service delivery system. A reasonably accurate model of the service delivery system is provided by embodiments disclosed herein, even though data for the model is collected from multiple, highly variable sources having incompleteness and inaccuracies. The modeling technique disclosed herein may use the multiple models without requiring staged models, hybrid models, or the generation of best of breed models using an arbitrator. Although systems and methods described herein disclose a service delivery system, embodiments of the present invention contemplate models of other systems that are modeled based on inaccurate and/or incomplete data, such as manufacturing lines, transportation facilities and networks.

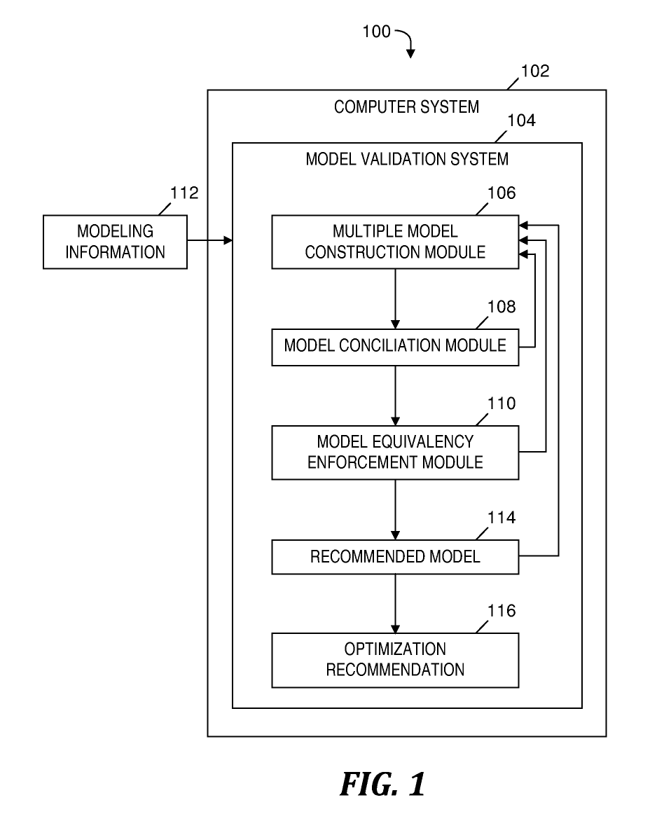

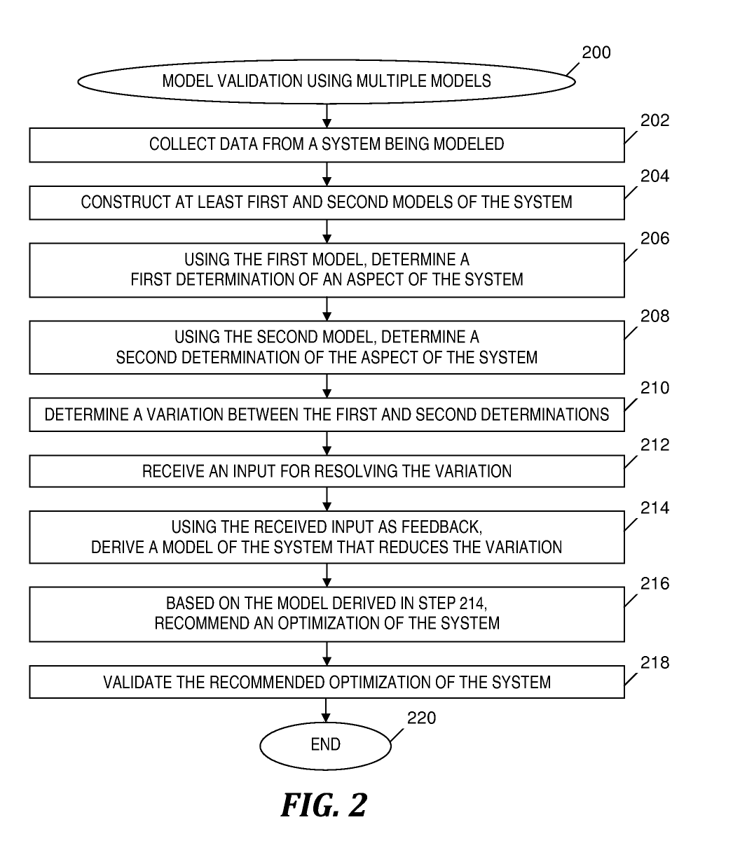

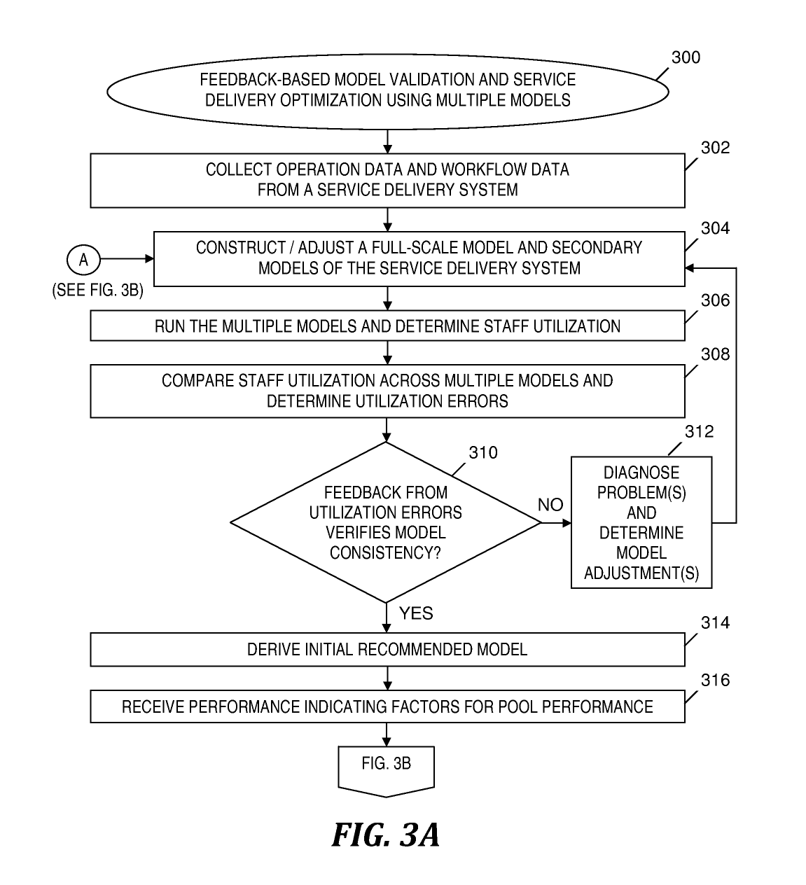

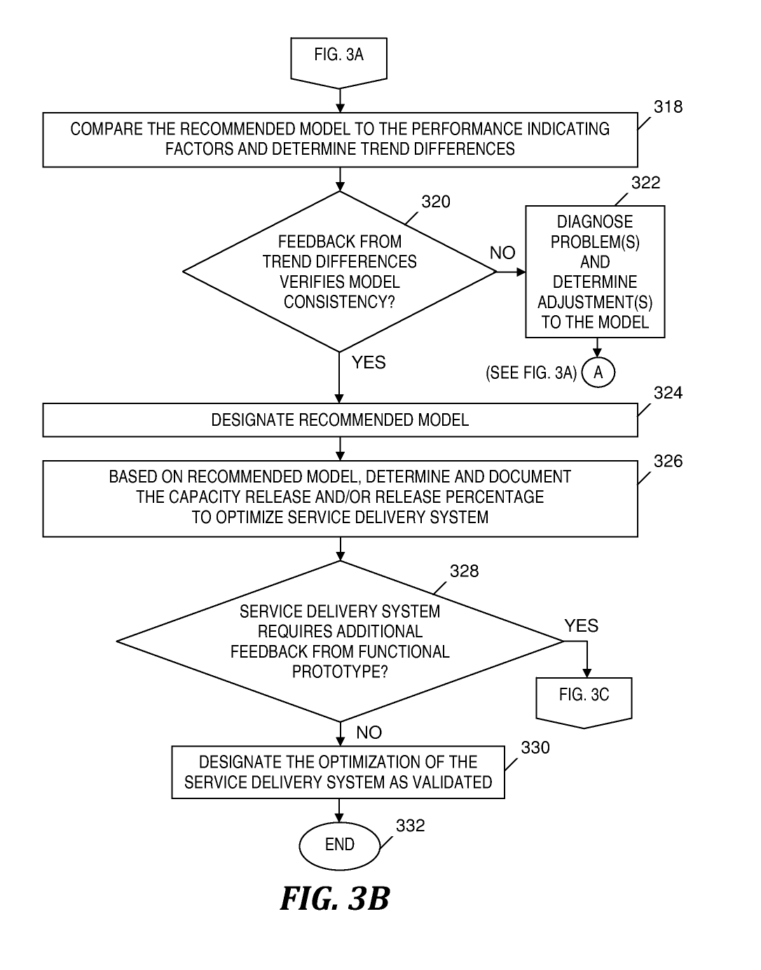

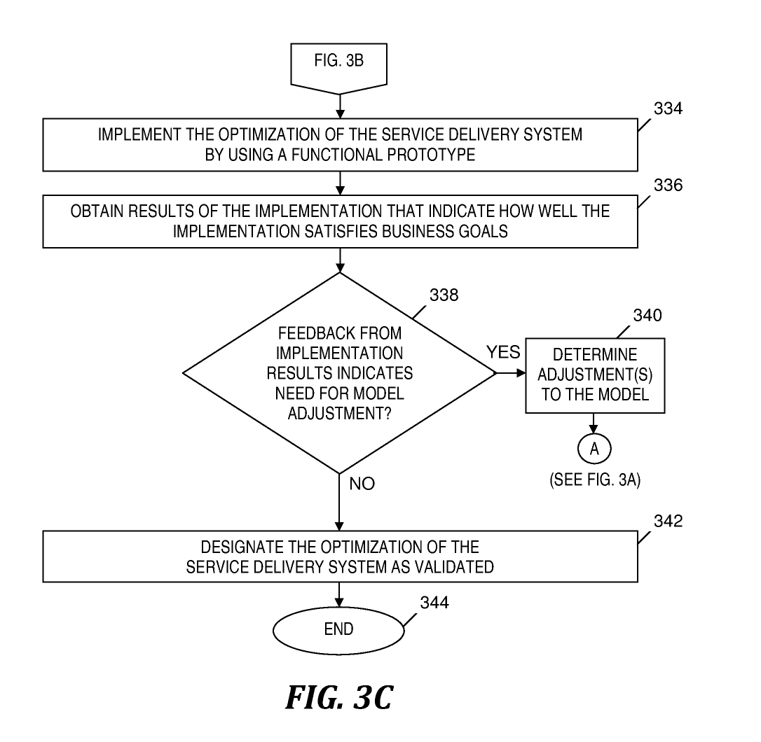

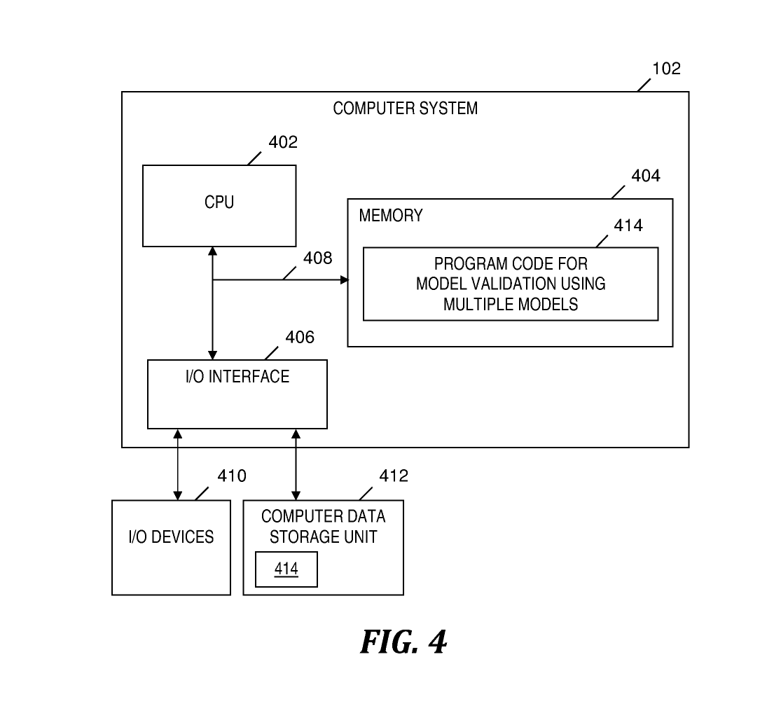

The detailed description is organized as follows. First, the discussion of FIG. 1 describes an embodiment of the overall system for validating a model using multiple models and feedback-based approaches, and explains modules included in the overall system. Second, the discussion of FIG. 2 describes one aspect of the model validation process included in an embodiment of the present invention, where the aspect includes the use of multiple models including one full-scale model and several secondary supporting models. Third, the discussion of FIGS. 3A-3C describes an embodiment of the whole model validation process including the use of multiple models and the use of three feedback loops on model construction, model recommendation, and model implementation. Finally, the discussion of FIG. 4 describes a computer system that may implement the aforementioned system and processes.

### System for Validating a Model Using Multiple Models and Feedback-Based Approaches

FIG. 1 is a block diagram of a system for validating a model using multiple models and feedback-based approaches, in accordance with embodiments of the present invention. System 100 includes a computer system 102 that runs a software-based model validation system 104, which includes a multiple model construction module 106, a model conciliation module 108, and a model equivalency enforcement module 110. Model validation system 104 collects modeling information 112 that includes data from a system being modeled. In one embodiment, modeling information 112 includes operation data and workflow data of an IT service delivery system being modeled. Using modeling information 112, multiple model construction module 106 constructs and runs multiple models to determine an aspect (i.e., a key performance indicator or KPI) of the system, such as staff utilization, across the multiple models. Model conciliation module 108 checks consistency across the multiple models based on the aspect of the system. If model conciliation module 108 determines that consistency across the models is lacking, then model conciliation module 108 provides a feedback loop back to multiple model construction module 106, which makes adjustments to one or more of the multiple models, and the consistency check by the model conciliation module 108 is repeated across the adjusted multiple models. If model conciliation module 108 determines that there is consistency across the multiple models, then model equivalency enforcement module 110 derives an initial recommended model (i.e., a to-be model).

Model equivalency enforcement module 110 performs a second consistency check based on trend differences revealed by comparing attributes of the initial recommended model with performance indicating factors across one or multiple pools of resources (e.g., groups or teams of individuals, such as a group of technicians or a group of system administrators). Hereinafter, a pool of resources is also simply referred to as a “pool.” If model equivalency enforcement module 110 determines that consistency based on the trend differences is lacking, then module 110 provides a feedback loop back to multiple model construction module 106, which makes adjustments to one or more of the multiple models, and the consistency checks by the model conciliation module 108 and the model equivalency enforcement module 110 are repeated. If model equivalency enforcement module 110 determines that there is consistency based on the trend differences, then module 110 derives a subsequent recommended model 114. Model validation system 104 uses recommended model 114 to generate an optimization recommendation 116 (i.e., a recommendation of an optimization of the system being modeled).

Model validation system 104 may use additional feedback from a functional prototype (not shown) of the service delivery system to determine how well an implementation of optimization recommendation 116 satisfies business goals. If the business goals are not adequately satisfied by the implementation, then model validation system 104 provides a feedback loop back to multiple model construction module 106, which makes further adjustments to the models, and model validation system 104 repeats the checks described above to derive an updated recommended model 114. Model validation system 104 uses the updated recommended model 114 to generate an updated optimization recommendation 116.

The functionality of the components of system 100 is further described below relative to FIG. 2, FIGS. 3A-3C and FIG. 4.

### Process for Validating a Model Using Multiple Models

FIG. 2 is a flowchart of a process of validating a model using multiple models, where the process is implemented in the system of FIG. 1, in accordance with embodiments of the present invention. The process of validating a model using multiple models starts at step 200. In step 202, model validation system 104 (see FIG. 1) collects data from the system being modeled. In one embodiment, the data collected in step 202 includes operational data and workflow data of the system being modeled. In one embodiment described below relative to FIGS. 3A-3C, the data collected in step 202 includes operational data and workflow data of a service delivery system being modeled.

The data collected in step 202 may be incomplete and may include a large amount of variation and inaccuracy. For example, the data may be incomplete because some system administrators (SAs) may not record all activities, and the non-recorded activities may not be a random sampling.

In step 204, multiple model construction module 106 (see FIG. 1) constructs multiple models, including a first model and a second model, using the data collected in step 202. In one embodiment, multiple model construction module 106 (see FIG. 1) constructs one full-scale model (e.g., discrete event simulation model) and multiple secondary, supporting models (e.g., a model based on queueing formula and a system heuristics model). The variation and inaccuracy present in the data collected in step 202 enter the models constructed in step 204 in different ways.

In step 206, model conciliation module 108 (see FIG. 1) runs the first model constructed in step 204 to determine a first determination of an aspect (i.e., KPI) of the system being modeled. The aspect determined in step 206 may be a measure of utilization of a resource by the system being modeled based on the first model (e.g., staff utilization). Other examples of a KPI determined in step 206 may include overtime or the number of contract workers to hire.

In step 208, model conciliation module 108 (see FIG. 1) runs the second model constructed in step 204 to determine a second determination of the same aspect (i.e., same KPI) of the system that was determined in step 206. The aspect of the system determined in step 208 may be a measure of utilization of a resource by the system being modeled based on the second model (e.g., staff utilization).

In step 210, model conciliation module 108 (see FIG. 1) determines a variation (e.g., utilization error) between the first determination of the aspect determined in step 206 and the second determination of the aspect determined in step 208. Model conciliation module 108 (see FIG. 1) determines whether or not the multiple models constructed in step 204 are consistent with each other based on the variation determined in step 210 and based on a specified desired accuracy of a recommended model that is to be used to optimize the system being modeled. Model validation system 104 (see FIG. 1) receives the specified desired accuracy of the recommended model prior to step 210.

In step 212, model conciliation module 108 (see FIG. 1) receives an input for resolving the variation determined in step 210 and sends the input as feedback to multiple model construction module 106 (see FIG. 1). In step 214, using the input received in step 212 as feedback, multiple model construction module 106 (see FIG. 1) derives a model of the system that reduces the variation determined in step 210.

Although not shown in FIG. 2, model equivalency enforcement module 110 (see FIG. 1) may obtain performance indicating factors (e.g., time and motion (T&M) study participation rate and tickets per SA) for a pool, compare one or more aspects of the model derived in step 214 (e.g., capacity release) with the obtained performance indicating factors, and identify variations (e.g., trend differences) based on the comparison between the aforementioned aspect(s) of the model and the performance indicating factors. Based on the identified variations as additional feedback, model equivalency enforcement module 110 (see FIG. 1) verifies consistency among the models constructed in step 204 and the model derived in step 214. If the aforementioned consistency cannot be verified, then multiple model construction module 106 (see FIG. 1) adjusts the model derived in step 214.

In step 216, based on the model derived in step 214, model validation system 104 (see FIG. 1) recommends an optimization of the system (e.g., by recommending staffing levels for a service delivery team). In step 218, model validation system 104 (see FIG. 1) validates the recommended optimization of the system. The process of FIG. 2 ends at step 220.

### Feedback-Based Model Validation & Service Delivery Optimization Using Multiple Models

FIGS. 3A-3C depict a flowchart of a process of feedback-based model validation and service delivery optimization using multiple models, where the process is implemented in the system of FIG. 1, in accordance with embodiments of the present invention. The process of FIGS. 3A-3C begins at step 300 in FIG. 3A. In step 302, model validation system 104 (see FIG. 1) collects data from the service delivery system being modeled. In one embodiment, the data collected in step 302 includes operational data and workflow data of the service delivery system.

Similar to the data collected in step 202 (see FIG. 2), the data collected in step 302 may be incomplete and may include a large amount of variation and inaccuracy.

In step 304, multiple model construction module 106 (see FIG. 1) constructs multiple models of the service delivery system, including a full-scale model (e.g., discrete event simulation model) and one or more secondary models (e.g., a model based on queueing formula and a system heuristics model), using the data collected in step 202.

In one embodiment, the full-scale model constructed in step 304 is the discrete event simulation model, which is based on work types and arrival rate, service times for work types, and other factors such as shifts and availability of personnel. One secondary model constructed in step 304 may be based on the queueing formula, is based on arrival time and service time, and uses a formula for utilization (i.e., mean arrival rate divided by mean service rate) and Little's theorem. Another secondary model constructed in step 304 may be a system heuristics model that is based on pool performance and agent behaviors. For example, the system heuristics model may be based on tickets per SA and T&M participation rate.

In step 306, model conciliation module 108 (see FIG. 1) runs the full-scale model constructed in step 304 to determine a first staff utilization of the service delivery system modeled by the full-scale model. Also in step 306, model conciliation module 108 (see FIG. 1) runs the secondary model(s) constructed in step 304 to determine staff utilization(s) of the service delivery system modeled by the secondary model(s).

In one example, a secondary model run in step 306 is based on a queueing formula considering ticket/non-ticket, business hours and shift, where arrival rate is equal to (weekly ticket volume+weekly non-ticket volume)/(5*9), where service rate is equal to 1/(weighted average service time from both ticket and non-ticket)*(total staffing), and where utilization is equal to arrival rate/service rate. Another secondary model run in step 306 is a system heuristics model, where utilization is equal to (ticket work time/SA/Day as adjusted by the volume of the ticketing system+non-ticket work time/SA/Day)/9. It should be noted that the numbers 5 and 9 are included in mathematical expressions in this paragraph based on an embodiment in which the SAs are working 5 days per week and 9 hours per day.

In step 308, model conciliation module 108 (see FIG. 1) determines utilization errors by comparing the staff utilizations determined in step 306 across multiple models. In step 310, model conciliation module 108 (see FIG. 1) determines whether or not the multiple models constructed in step 304 are consistent with each other based on the utilization errors determined in step 308 and based on a specified desired accuracy of a recommended model that is to be used to optimize the service delivery system. Model validation system 104 (see FIG. 1) receives the specified desired accuracy of the recommended model prior to step 308.

If model conciliation module 108 (see FIG. 1) determines that the aforementioned multiple models are not consistent with each other, then the No branch of step 310 is taken and step 312 is performed. In step 312, model conciliation module 108 (see FIG. 1) diagnoses the problem(s) that are causing the inconsistency among the multiple models and determines adjustment(s) to the models to correct the problem(s). In one example, an inconsistency between the queueing model and the heuristics model may indicate that the arrival patterns or service time distributions are not correctly derived from the collected operation data and workflow data. In another example, an inconsistency between the simulation model and the queueing model may indicate the shift or queueing discipline is not correctly implemented. After step 312, the process of FIGS. 3A-3C loops back to step 304, in which multiple model construction module 106 (see FIG. 1) receives the adjustments determined in step 312 and adjusts the full-scale model and secondary model(s) based on the adjustments determined in step 312.

Returning to step 310, if model conciliation module 108 (see FIG. 1) determines that the aforementioned multiple models constructed in step 304 (or the multiple models adjusted via the loop that starts after step 312) are consistent with each other, then the Yes branch of step 310 is taken, and step 314 is performed.

In step 314, model conciliation module 108 (see FIG. 1) derives an initial recommended model (i.e., to-be recommendation) of the service delivery system. For example, for a discrete event simulation model as the full-scale model constructed in step 304, step 314 may include defining the to-be state so that the to-be recommendation has a service level agreement attainment level that is substantially similar to the models constructed in step 304, and so that the staff utilization is within a specified tolerance of 80% to increase the robustness of the model recommendation anticipating workload variations.

In step 316, model equivalency enforcement module 110 (see FIG. 1) receives the initial recommended model derived in step 314 and receives performance indicating factors for pool performance. For example, the performance indicating factors may include tickets per SA and T&M participation rate. T&M participation rate is participating staff/total staff, where total staff includes staff that is not working and staff that is not reporting in the T&M study.

After step 316, the process of FIGS. 3A-3C continues with step 318 in FIG. 3B. In step 318, model equivalency enforcement module 110 (see FIG. 1) determines trend differences between aspects of the initial recommended model derived in step 314 (see FIG. 3A) and the performance indicating factors received in step 316 (see FIG. 3A) by comparing the capacity release and/or the release percentage of the service delivery system modeled by the initial recommended model derived in step 314 (see FIG. 3A) with the performance indicating factors received in step 316 (see FIG. 3A). With respect to staffing, capacity release is a positive or negative number indicating the difference between the current staffing and the to-be staffing (i.e., the staffing based on the to-be recommendation). A positive capacity release means that the to-be staffing is a decrease in staff as compared to the current staffing. A negative capacity release means that the to-be staffing is an increase in staff as compared to the current staffing. Similarly, a release percentage may be a positive or negative percentage, where a positive release percentage is equal to a positive capacity release divided by the current staffing, and a negative release percentage is equal to a negative capacity release divided by the current staffing.

In step 320, model equivalency enforcement module 110 (see FIG. 1) determines whether or not the initial recommended model derived in step 314 (see FIG. 3A) and the multiple models constructed in step 304 (see FIG. 3A) are consistent with each other based on the trend differences determined in step 318 and based on the aforementioned specified desired accuracy of a recommended model that is to be used to optimize the service delivery system.

If model equivalency enforcement module 110 (see FIG. 1) determines in step 320 that the initial recommended model derived in step 314 (see FIG. 3A) and the multiple models constructed or adjusted in step 304 (see FIG. 3A) are not consistent with each other, then the No branch of step 320 is taken and step 322 is performed. In step 322, model equivalency enforcement module 110 (see FIG. 1) diagnoses the problem(s) that are causing the inconsistency among the models and determines adjustment(s) to the initial recommended model derived in step 314 (see FIG. 3A) to correct the problem(s). After step 322, the process of FIGS. 3A-3C loops back to step 304 (see FIG. 3A), in which multiple model construction module 106 (see FIG. 1) receives the adjustment(s) determined in step 322 and adjusts the initial recommended model based on the adjustment(s) determined in step 322.

Returning to step 320, if model equivalency enforcement module 110 (see FIG. 1) determines that the aforementioned models are consistent with each other, then the Yes branch of step 320 is taken, and step 324 is performed.

In step 324, model equivalency enforcement module 110 (see FIG. 1) designates the initial recommended model as a final recommended model (i.e., recommended model 114 in FIG. 1) if the No branch of step 320 was not taken. If the No branch of step 320 was taken, then in step 324, model equivalency enforcement module 110 (see FIG. 1) designates the most recent adjusted recommended model as the final recommended model.

In step 326, based on the recommended model designated in step 324, model validation system 104 (see FIG. 1) determines and stores the capacity release and/or the release percentage that is needed to optimize the service delivery system.

In step 328, model validation system 104 (see FIG. 1) determines whether or not the service delivery system requires additional feedback from a functional prototype. If model validation system 104 (see FIG. 1) determines in step 328 that additional feedback from a functional prototype (not shown in FIG. 1) of the service delivery system is not needed, then the No branch of step 328 is taken and step 330 is performed. In step 330, model validation system 104 (see FIG. 1) determines the optimization recommendation 116 (see FIG. 1) of the service delivery system and designates the optimization as validated. The process of FIGS. 3A-3C ends at step 332.

Returning to step 328, if model validation system 104 (see FIG. 1) determines that additional feedback from the functional prototype is needed, then the Yes branch of step 328 is taken and step 334 in FIG. 3C is performed.

In step 334, model validation system 104 (see FIG. 1) implements the optimization of the service delivery system by using the functional prototype.

In step 336, model validation system 104 (see FIG. 1) obtains results of the implementation performed in step 334, where the results indicate how well the implementation satisfies business goals.

In step 338, model validation system 104 (see FIG. 1) determines whether or not feedback from the results obtained in step 336 indicates a need for adjustment(s) to the recommended model designated in step 324 (see FIG. 3B).

If model validation system 104 (see FIG. 1) determines in step 338 that the results obtained in step 336 indicate a need for adjustment(s) to the recommended model designated in step 324 (see FIG. 3B), then the Yes branch of step 338 is taken and step 340 is performed. In step 340, model validation system determines adjustment(s) to the recommended model designated in step 324 (see FIG. 3B) and the process of FIGS. 3A-3C loops back to step 304 in FIG. 3A, with multiple model construction module 106 (see FIG. 1) making the adjustment(s) to the recommended model 114 (see FIG. 1) and optimization recommendation 116 (see FIG. 1).

If model validation system 104 (see FIG. 1) determines in step 338 that the results obtained in step 336 do not indicate a need for the aforementioned adjustment(s), then the No branch of step 338 is taken and step 342 is performed. In step 342, model validation system 104 (see FIG. 1) designates the optimization recommendation 116 (see FIG. 1) as validated. The process of FIGS. 3A-3C ends at step 344.

### Computer System

FIG. 4 is a block diagram of a computer system that is included in the system of FIG. 1 and that implements the process of FIG. 2 or the process of FIGS. 3A-3C, in accordance with embodiments of the present invention. Computer system 102 generally comprises a central processing unit (CPU) 402, a memory 404, an input/output (I/O) interface 406, and a bus 408. Further, computer system 102 is coupled to I/O devices 410 and a computer data storage unit 412. CPU 402 performs computation and control functions of computer system 102, including carrying out instructions included in program code 414 to implement the functionality of model validation system 104 (see FIG. 1), where the instructions are carried out by CPU 402 via memory 404. CPU 402 may comprise a single processing unit, or be distributed across one or more processing units in one or more locations (e.g., on a client and server). In one embodiment, program code 414 includes code for model validation using multiple models and feedback-based approaches.

Memory 404 may comprise any known computer-readable storage medium, which is described below. In one embodiment, cache memory elements of memory 404 provide temporary storage of at least some program code (e.g., program code 414) in order to reduce the number of times code must be retrieved from bulk storage while instructions of the program code are carried out. Moreover, similar to CPU 402, memory 404 may reside at a single physical location, comprising one or more types of data storage, or be distributed across a plurality of physical systems in various forms. Further, memory 404 can include data distributed across, for example, a local area network (LAN) or a wide area network (WAN).

I/O interface 406 comprises any system for exchanging information to or from an external source. I/O devices 410 comprise any known type of external device, including a display device (e.g., monitor), keyboard, mouse, printer, speakers, handheld device, facsimile, etc. Bus 408 provides a communication link between each of the components in computer system 102, and may comprise any type of transmission link, including electrical, optical, wireless, etc.

I/O interface 406 also allows computer system 102 to store information (e.g., data or program instructions such as program code 414) on and retrieve the information from computer data storage unit 412 or another computer data storage unit (not shown). Computer data storage unit 412 may comprise any known computer-readable storage medium, which is described below. For example, computer data storage unit 412 may be a non-volatile data storage device, such as a magnetic disk drive (i.e., hard disk drive) or an optical disc drive (e.g., a CD-ROM drive which receives a CD-ROM disk).

Memory 404 and/or storage unit 412 may store computer program code 414 that includes instructions that are carried out by CPU 402 via memory 404 to validate a model and optimize service delivery using multiple models and feedback-based approaches. Although FIG. 4 depicts memory 404 as including program code 414, the present invention contemplates embodiments in which memory 404 does not include all of code 414 simultaneously, but instead at one time includes only a portion of code 414.

Further, memory 404 may include other systems not shown in FIG. 4, such as an operating system (e.g., Linux®) that runs on CPU 402 and provides control of various components within and/or connected to computer system 102. Linux is a registered trademark of Linus Torvalds in the United States.

Storage unit 412 and/or one or more other computer data storage units (not shown) that are coupled to computer system 102 may store modeling information 112 (see FIG. 1), recommended model 114 (see FIG. 1) and/or optimization recommendation 116 (see FIG. 1).

As will be appreciated by one skilled in the art, the present invention may be embodied as a system, method or computer program product. Accordingly, an aspect of an embodiment of the present invention may take the form of an entirely hardware aspect, an entirely software aspect (including firmware, resident software, micro-code, etc.) or an aspect combining software and hardware aspects that may all generally be referred to herein as a “module”. Furthermore, an embodiment of the present invention may take the form of a computer program product embodied in one or more computer-readable medium(s) (e.g., memory 404 and/or computer data storage unit 412) having computer-readable program code (e.g., program code 414) embodied or stored thereon.

Any combination of one or more computer-readable mediums (e.g., memory 404 and computer data storage unit 412) may be utilized. The computer readable medium may be a computer-readable signal medium or a computer-readable storage medium. In one embodiment, the computer-readable storage medium is a computer-readable storage device or computer-readable storage apparatus. A computer-readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be a tangible medium that can contain or store a program (e.g., program 414) for use by or in connection with a system, apparatus, or device for carrying out instructions.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 414) embodied on a computer-readable medium may be transmitted using any appropriate medium, including but not limited to wireless, wireline, optical fiber cable, RF, etc., or any suitable combination of the foregoing.

Computer program code (e.g., program code 414) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Java and all Java-based trademarks and logos are trademarks or registered trademarks of Oracle and/or its affiliates. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 4. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIG. 2 and FIGS. 3A-3C) and/or block diagrams of methods, apparatus (systems) (e.g., FIG. 1 and FIG. 4), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 414). These computer program instructions may be provided to one or more hardware processors (e.g., CPU 402) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowcharts and/or block diagram block or blocks.

These computer program instructions may also be stored in a computer-readable medium (e.g., memory 404 or computer data storage unit 412) that can direct a computer (e.g., computer system 102), other programmable data processing apparatus, or other devices to function in a particular manner, such that the instructions (e.g., program 414) stored in the computer-readable medium produce an article of manufacture including instructions which implement the function/act specified in the flowcharts and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 414) which are carried out on the computer, other programmable apparatus, or other devices provide processes for implementing the functions/acts specified in the flowcharts and/or block diagram block or blocks.

The flowcharts in FIG. 2 and FIGS. 3A-3C and the block diagrams in FIG. 1 and FIG. 4 illustrate the architecture, functionality, and operation of possible implementations of systems, methods, and computer program products according to various embodiments of the present invention. In this regard, each block in the flowcharts or block diagrams may represent a module, segment, or portion of code (e.g., program code 414), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method of modeling a service delivery system, the method comprising the steps of:
a computer system having a hardware processor collecting data from the service delivery system;
the computer system constructing first, second and third models of the service delivery system from the collected data, the first model being a discrete event simulation model based work types, arrival rate, and service times for the work types, the second model being a queueing model based on a queueing formula that uses Little's theorem, arrival time, service time, and a mean arrival rate divided by a mean service rate, and the third model being a system heuristics model based on pool performance and agent behaviors;
based on the discrete event simulation model, the queueing model, and the system heuristics model, the computer system determining a first utilization error that indicates first variations among measures of utilization of staffing by the service delivery system;
based on the first utilization error, the computer system determining a problem that causes the first variations among the measures of the utilization of staffing, and in response, determining adjustments to the discrete event simulation, queueing, and system heuristics models to correct the problem that causes the first variations;
the computer system determining a second utilization error that indicates second variations among other measures of the utilization of staffing by the service delivery system which are based on the adjustments; and
based on the second utilization error, the computer system determining a consistency among the adjusted discrete event simulation, queueing, and system heuristics models, and in response, deriving an initial recommended model of the service delivery system.

2. The method of claim 1, further comprising the steps of:
subsequent to the step of deriving the initial recommended model, the computer system receiving performance indicating factors indicating measures of performance across multiple pools of resources utilized by the service delivery system; and
the computer system determining a variation between the performance indicating factors and a first capacity release of the service delivery system modeled by the initial recommended model, the first capacity release indicating a difference between current staffing and to-be staffing based on the initial recommended model.

3. The method of claim 2, further comprising the steps of:
the computer system determining trend differences that indicate the variation between the performance indicating factors and the first capacity release of the service delivery system modeled by the initial recommended model; and
based on the trend differences, the computer system deriving a subsequent recommended model of the service delivery system, wherein the subsequent recommended model reduces the trend differences.

4. The method of claim 3, further comprising the steps of:
the computer system determining the trend differences indicate a lack of consistency between the discrete event simulation, queuing, and system heuristic models; and
based on the lack of consistency, the computer system adjusting the discrete event simulation model, wherein the step of the computer system deriving the subsequent recommended model based on the trend differences includes deriving the subsequent recommended model from the discrete event simulation model adjusted based on the lack of consistency, and wherein the subsequent recommended model reduces the trend differences.

5. The method of claim 3, further comprising the step of based on the subsequent recommended model, the computer system recommending a level of staffing required to optimize the service delivery system.

6. The method of claim 5, further comprising the step of the computer system validating the recommended level of staffing required to optimize the service delivery system.

7. The method of claim 1, wherein the step of the computer system collecting data from the service delivery system includes the computer system collecting operation data of the service delivery system and workflow data of the service delivery system, and wherein the step of determining the problem that causes the first variations among the measures of the utilization of staffing includes determining arrival patterns or service time distributions are not correctly derived from the operation data and the workflow data.

8. A computer system comprising:
a central processing unit (CPU);
a memory coupled to the CPU; and
a computer-readable, tangible storage device coupled to the CPU, the storage device not being a transitory form of signal transmission, and the storage device containing program instructions that, when executed by the CPU via the memory, implement a method of modeling a service delivery system, the method comprising the steps of:
the computer system collecting data from the service delivery system;
the computer system constructing first, second and third models of the service delivery system from the collected data, the first model being a discrete event simulation model based work types, arrival rate, and service times for the work types, the second model being a queueing model based on a queueing formula that uses Little's theorem, arrival time, service time, and a mean arrival rate divided by a mean service rate, and the third model being a system heuristics model based on pool performance and agent behaviors;
based on the discrete event simulation model, the queueing model, and the system heuristics model, the computer system determining a first utilization error that indicates first variations among measures of utilization of staffing by the service delivery system;
based on the first utilization error, the computer system determining a problem that causes the first variations among the measures of the utilization of staffing, and in response, determining adjustments to the discrete event simulation, queueing, and system heuristics models to correct the problem that causes the first variations;
the computer system determining a second utilization error that indicates second variations among other measures of the utilization of staffing by the service delivery system which are based on the adjustments; and
based on the second utilization error, the computer system determining a consistency among the adjusted discrete event simulation, queueing, and system heuristics models, and in response, deriving an initial recommended model of the service delivery system.

9. The computer system of claim 8, wherein the method further comprises the steps of:
subsequent to the step of deriving the initial recommended model, the computer system receiving performance indicating factors indicating measures of performance across multiple pools of resources utilized by the service delivery system; and
the computer system determining a variation between the performance indicating factors and a first capacity release of the service delivery system modeled by the initial recommended model, the first capacity release indicating a difference between current staffing and to-be staffing based on the initial recommended model.

10. The computer system of claim 9, wherein the method further comprises the steps of:
the computer system determining trend differences that indicate the variation between the performance indicating factors and the first capacity release of the service delivery system modeled by the initial recommended model; and
based on the trend differences, the computer system deriving a subsequent recommended model of the service delivery system, wherein the subsequent recommended model reduces the trend differences.

11. The computer system of claim 10, wherein the method further comprises the steps of:
the computer system determining the trend differences indicate a lack of consistency between the discrete event simulation, queuing, and system heuristic models; and
based on the lack of consistency, the computer system adjusting the discrete event simulation model, wherein the step of the computer system deriving the subsequent recommended model based on the trend differences includes deriving the subsequent recommended model from the discrete event simulation model adjusted based on the lack of consistency, and wherein the subsequent recommended model reduces the trend differences.

12. The computer system of claim 10, wherein the method further comprises the step of based on the subsequent recommended model, the computer system recommending a level of staffing required to optimize the service delivery system.

13. The computer system of claim 12, wherein the method further comprises the step of the computer system validating the recommended level of staffing required to optimize the service delivery system.

14. The computer system of claim 8, wherein the step of the computer system collecting data from the service delivery system includes the computer system collecting operation data of the service delivery system and workflow data of the service delivery system, and wherein the step of determining the problem that causes the first variations among the measures of the utilization of staffing includes determining arrival patterns or service time distributions are not correctly derived from the operation data and the workflow data.

15. A computer program product comprising:
a computer-readable, tangible storage device comprising hardware; and
computer-readable program instructions stored on the computer-readable, tangible storage device, the computer-readable program instructions, when executed by a central processing unit (CPU) of a computer system, implement a method of modeling a service delivery system, the method comprising the steps of:
the computer system collecting data from the service delivery system;
the computer system constructing first, second and third models of the service delivery system from the collected data, the first model being a discrete event simulation model based work types, arrival rate, and service times for the work types, the second model being a queueing model based on a queueing formula that uses Little's theorem, arrival time, service time, and a mean arrival rate divided by a mean service rate, and the third model being a system heuristics model based on pool performance and agent behaviors;
based on the discrete event simulation model, the queueing model, and the system heuristics model, the computer system determining a first utilization error that indicates first variations among measures of utilization of staffing by the service delivery system;
based on the first utilization error, the computer system determining a problem that causes the first variations among the measures of the utilization of staffing, and in response, determining adjustments to the discrete event simulation, queueing, and system heuristics models to correct the problem that causes the first variations;
the computer system determining a second utilization error that indicates second variations among other measures of the utilization of staffing by the service delivery system which are based on the adjustments; and
based on the second utilization error, the computer system determining a consistency among the adjusted discrete event simulation, queueing, and system heuristics models, and in response, deriving an initial recommended model of the service delivery system.

16. The computer program product of claim 15, wherein the method further comprises the steps of:
subsequent to the step of deriving the initial recommended model, the computer system receiving performance indicating factors indicating measures of performance across multiple pools of resources utilized by the service delivery system; and
the computer system determining a variation between the performance indicating factors and a first capacity release of the service delivery system modeled by the initial recommended model, the first capacity release indicating a difference between current staffing and to-be staffing based on the initial recommended model.

17. The computer program product of claim 16, wherein the method further comprises the steps of:
the computer system determining trend differences that indicate the variation between the performance indicating factors and the first capacity release of the service delivery system modeled by the initial recommended model; and
based on the trend differences, the computer system deriving a subsequent recommended model of the service delivery system, wherein the subsequent recommended model reduces the trend differences.

18. The computer program product of claim 17, wherein the method further comprises the steps of:
the computer system determining the trend differences indicate a lack of consistency between the discrete event simulation, queuing, and system heuristic models; and
based on the lack of consistency, the computer system adjusting the discrete event simulation model, wherein the step of the computer system deriving the subsequent recommended model based on the trend differences includes deriving the subsequent recommended model from the discrete event simulation model adjusted based on the lack of consistency, and wherein the subsequent recommended model reduces the trend differences.

19. The computer program product of claim 17, wherein the method further comprises the step of based on the subsequent recommended model, the computer system recommending a level of staffing required to optimize the service delivery system.

20. The computer program product of claim 19, wherein the method further comprises the step of the computer system validating the recommended level of staffing required to optimize the service delivery system.
